(19) United States
(12) Patent Application Publication
(10) Pub. No.: US 2025/0034931 A1
(43) Pub. Date: Jan. 30, 2025

(54) DOOR OPENING AND CLOSING ASSISTANCE DEVICE

(71) Applicant: MITSUI KINZOKU ACT CORPORATION, Kanagawa (JP)

(72) Inventor: Osamu KAWANOBE, Kanagawa (JP)

(73) Assignee: MITSUI KINZOKU ACT CORPORATION, Kanagawa (JP)

(21) Appl. No.: 18/783,107

(22) Filed: Jul. 24, 2024

(30) Foreign Application Priority Data
Jul. 28, 2023 (JP) 2023-123156

(51) Int. Cl. E05F 15/695; E05F 15/611

(52) U.S. Cl. CPC E05F 15/695; E05F 15/611; E05Y 2400/3015; E05Y 2400/36; E05Y 2900/50

(57) ABSTRACT

A door opening and closing assistance device includes a motor generating power for assisting an operation force of a door supported on a vehicle body and allowed to be opened and closed, and a controller controlling the motor. The controller sets and cancels door balance control in which an output of the motor is controlled to balance a weight of the door in an opening and closing direction of the door such that the door is stationary, and power assistance control in which the output of the motor is controlled to generate an assistance force in the opening and closing direction. When a state that an opening and closing acceleration of the door is equal to or more than a threshold continues for predetermined time or more in a state that the door balance control is set, the controller switches from the door balance control to the power assistance control.

### CROSS-REFERENCE TO RELATED APPLICATIONS

This application is based on and claims priority under 35 USC 119 from Japanese Patent Application No. 2023-123156 filed on Jul. 28, 2023, the entire content of which is incorporated herein by reference.

### TECHNICAL FIELD

The present disclosure relates to a door opening and closing assistance device that assists an operation force in opening and closing a door of a vehicle.

### BACKGROUND ART

A door opening and closing assistance device that assists an operation force in opening and closing a door of a vehicle is known in the related art. JP6409212B discloses a door opening and closing assistance device that, for improving convenience of opening and closing assist, detects a manual operation with an angular speed sensor provided in a door and a sensor provided in a drive unit and generates an assistance force in an operation direction. JP2022-190503A discloses a door opening and closing assistance device that, for generating an appropriate assistance force according to an inclination of a vehicle, starts assistance control with a handle switch as a starting point and performs the assistance control while correcting the inclination according to a stored opening degree.

Although the door opening and closing assistance device disclosed in JP6409212B detects the manual operation of the door with the angular speed sensor, it may be difficult to generate an appropriate assistance force according to an inclination of a vehicle since it is difficult for the angular speed sensor to detect the inclination. On the other hand, although the door opening and closing assistance device disclosed in JP2022-190503A can generate an appropriate assistance force according to the inclination of the vehicle, there is an issue in terms of costs since a handle switch is required to start assist.

### SUMMARY OF INVENTION

The present disclosure provides a door opening and closing assistance device capable of holding a door in a vicinity of a desired position in a state that a door opening and closing operation can be easily performed while reducing costs.

A first aspect of the present disclosure relates to a door opening and closing assistance device, including:
a three-phase DC motor configured to generate power for assisting an operation force of a door that is supported on a vehicle body and allowed to be opened and closed; and
a controller configured to control the three-phase DC motor,
in which the controller is configured to set and cancel
   door balance control in which an output of the three-phase DC motor is controlled to balance a component of a weight of the door in an opening and closing direction of the door such that the door is stationary, and
   power assistance control in which the output of the three-phase DC motor is controlled to generate an assistance force in the opening and closing direction of the door, and
when a state that an opening and closing acceleration of the door is equal to or more than a third threshold continues for predetermined time or more in a state that the door balance control is set, the controller switches from the door balance control to the power assistance control.

A second aspect of the present disclosure relates to a door opening and closing assistance device, including:
a three-phase DC motor configured to assist an operation force of a door that is supported on a vehicle body and allowed to be opened and closed; and
a controller configured to control the three-phase DC motor,
in which the controller is configured to set and cancel
   pre-power assistance control in which an output of the three-phase DC motor is controlled such that a resultant force with a component of a weight of the door in an opening and closing direction of the door has a predetermined magnitude in a direction opposite to the opening and closing direction due to the weight of the door, to move the door, and
   power assistance control in which the output of the three-phase DC motor is controlled to generate an assistance force in the opening and closing direction of the door, and
when a state that an opening and closing acceleration of the door is equal to or more than a third threshold continues for predetermined time or more in a state that the pre-power assistance control is set, the controller switches from the pre-power assistance control to the power assistance control.

According to the aspects of the present disclosure, the door can be held in a vicinity of a desired position in a state that a door opening and closing operation can be easily performed. Accordingly, the door can be held in the vicinity of the desired position in a state that the door opening and closing operation can be easily performed while reducing costs.

### BRIEF DESCRIPTION OF DRAWINGS

Exemplary embodiment(s) of the present invention will be described in detail based on the following figures, wherein:

FIG. 1 is a rear perspective view of a vehicle equipped with a door opening and closing assistance device according to a first embodiment of the present disclosure;

FIG. 2 is a left side view of a rear portion of the vehicle in FIG. 1;

FIG. 3 is a sectional view of a main portion of an actuator of the door opening and closing assistance device according to the first embodiment of the present disclosure;

FIG. 4 is a block diagram of a control device of the door opening and closing assistance device according to the first embodiment of the present disclosure;

FIG. 5 shows an example of a two-phase energized state of a three-phase DC motor in the door opening and closing assistance device according to the first embodiment of the present disclosure;

FIG. 6 shows an example of a relationship between phases energized by door holding control and a rotational position of a rotor RT in the door opening and closing assistance device according to the first embodiment of the present disclosure;

FIG. 7 is a flowchart showing a process in assistance control executed by the control device of the door opening and closing assistance device according to the first embodiment of the present disclosure;

FIG. 8 is a left side view illustrating a side door of a vehicle equipped with a door opening and closing assistance device according to a second embodiment of the present disclosure; and

FIG. 9 is a flowchart showing a process in assistance control executed by a control device of the door opening and closing assistance device according to the second embodiment of the present disclosure.

### DESCRIPTION OF EMBODIMENTS

Embodiments of a door opening and closing assistance device of the present disclosure will be described with reference to the accompanying drawings. The drawings are viewed in orientations of reference numerals. In the present description and the like, to simplify and clarify the description, a front-rear direction, a left-right direction, and an up-down direction are described according to directions viewed from a driver of a vehicle equipped with the door opening and closing assistance device. In the drawings, Fr denotes a front side of the vehicle, Rr denotes a rear side, L denotes a left side, R denotes a right side, U denotes an upper side, and D denotes a lower side.

### First Embodiment

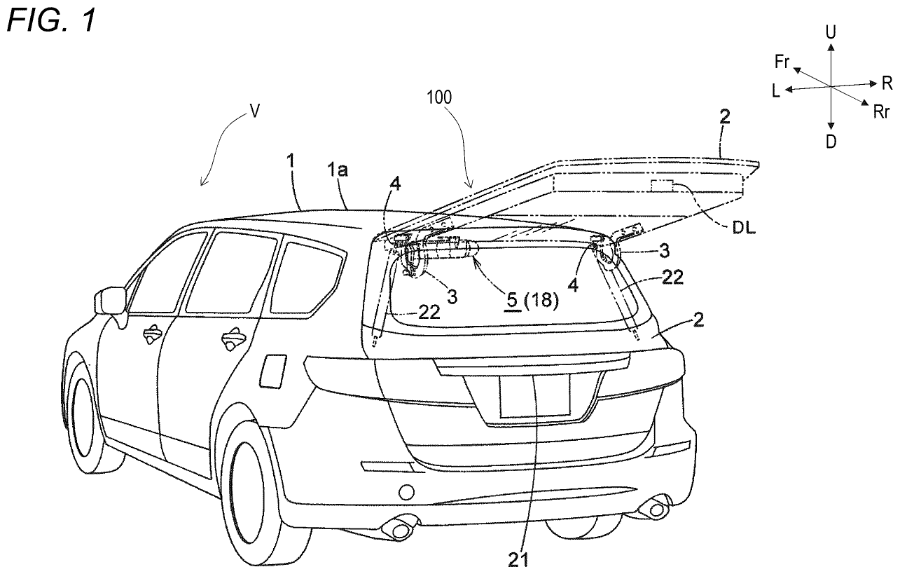

First, as a first embodiment of a door opening and closing assistance device of the present disclosure, a door opening and closing assistance device 100 that assists an operation force in opening and closing a back door of a vehicle V will be described with reference to FIGS. 1 to 5.

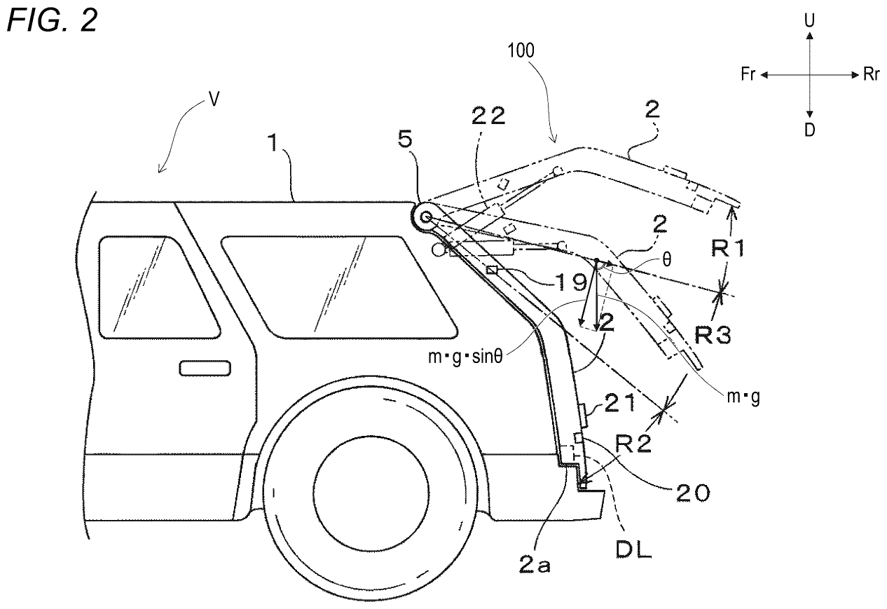

As illustrated in FIGS. 1 and 2, a back door 2, which is a flip-up hinged door, is supported on a vehicle body 1 of the vehicle V at a rear portion of the vehicle body 1 and allowed to be opened and closed in the up-down direction. The back door 2 is provided with a pair of left and right door hinges 3 at an upper end portion. The back door 2 is coupled to a rear upper portion of the vehicle body 1 via the door hinges 3, and is rotatable in the up-down direction about pivot shafts 4 of the door hinges 3 that are directed toward the left-right direction. The back door 2 is rotatable in an opening direction from a fully closed position indicated by solid lines in FIG. 2 to a fully opened position indicated by two-dot chain lines in FIG. 2 through an intermediate position similarly indicated by two-dot chain lines in FIG. 2, and is also rotatable in a reverse closing direction.

The back door 2 is provided with, at a distal end portion 2a opposite to the upper end portion of the back door 2, a door latch device DL that holds the back door 2 in the fully closed position by meshing with a striker (not illustrated) on a vehicle body side. The back door 2 is further provided with, on a rear surface, a release switch 21 that is operated when releasing the meshing between the door latch device DL and the striker and manually opening the back door 2.

The vehicle body 1 is provided with, on each of two side portions of a rear end, a gas spring 22 that urges the back door 2 in the opening direction. A temperature sensor 19, which detects an environmental temperature of the gas spring 22, is provided on or in a vicinity of the gas spring 22.

As illustrated in FIG. 2, an urging force of the gas spring 22 acting on the back door 2 is set to be a force capable of lifting the back door 2 to the fully opened position when the back door 2 is in an opening direction area R1 including the fully opened position, a force for the back door 2 to move in the closing direction by its own weight when the back door 2 is in a closing direction area R2 including the fully closed position, and a force balanced with a force for the back door 2 to move in the closing direction by its own weight when the back door 2 is in an intermediate area R3 between the opening direction area R1 and the closing direction area R2. Accordingly, the operation force when manually opening and closing the back door 2 is reduced.

The door opening and closing assistance device 100 is attached to the rear portion of the vehicle body 1.

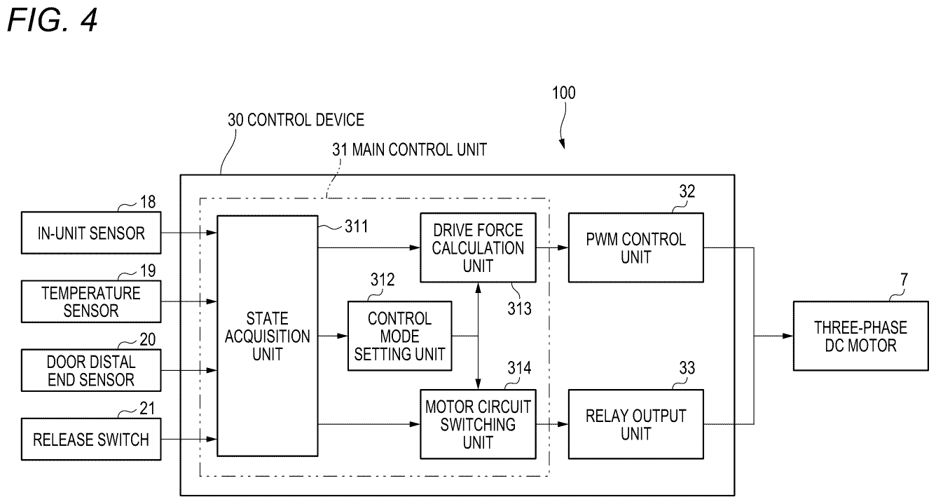

The door opening and closing assistance device 100 includes an actuator 5 provided at the rear upper portion of the vehicle body 1, a control device (controller) 30 (see FIG. 4) mountable in a freely selected position of the vehicle V, and a door distal end sensor 20 attached to the back door 2.

The door distal end sensor 20 is attached to the distal end portion 2a opposite to the upper end portion of the back door 2. The door distal end sensor 20 is a sensor that acquires a detection value for calculating at least one of an acceleration (opening and closing acceleration), a speed (opening and closing speed), and a movement distance of an opening and closing movement of the back door 2. The door distal end sensor 20 may be, for example, an angular speed sensor of a uniaxial analog gyro, and may also have a freely selected configuration as long as the sensor can acquire a detection value for accurately calculating at least one of the acceleration (opening and closing acceleration), the speed (opening and closing speed), and the movement distance of the opening and closing movement of the back door 2 at the distal end portion 2a of the back door 2.

Since the door distal end sensor 20 is attached to the distal end portion 2a opposite to the upper end portion of the back door 2, a movement amount of the door distal end sensor 20 is large when the back door 2 is opened and closed. Accordingly, the detection value for calculating at least one of the acceleration (opening and closing acceleration), the speed (opening and closing speed), and the movement distance of the opening and closing movement of the back door 2 can be relatively accurately acquired in the door distal end sensor 20.

The actuator 5 is disposed in a roof 1a of the vehicle body 1. A structure of the actuator 5 is not directly related to the present disclosure, and thus only a part related to the present disclosure and a rough overall configuration will be described and detailed description of other parts will be omitted.

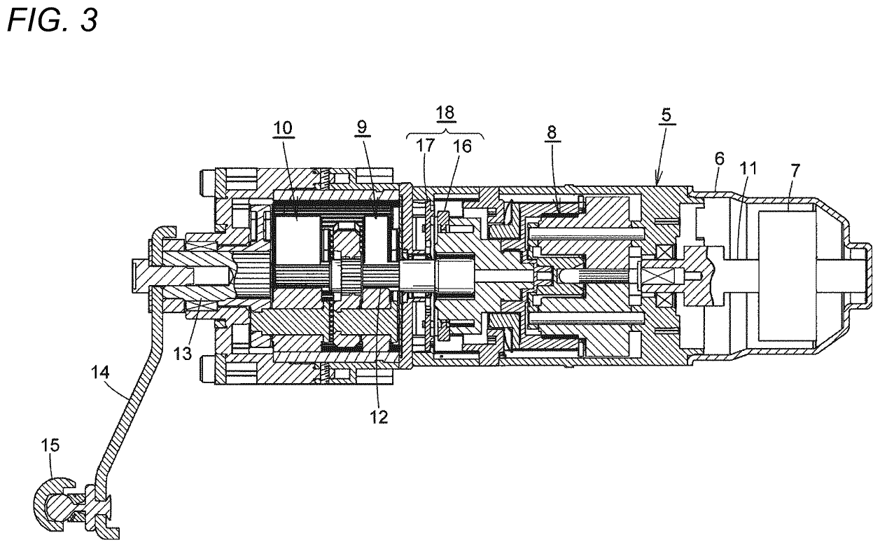

As illustrated in FIG. 3, the actuator 5 includes a tubular case 6 directed toward the left-right direction.

In the case 6 of the actuator 5, a three-phase DC motor 7 that generates power for assisting the operation force of the back door 2, a first planetary gear mechanism 8, a second planetary gear mechanism 9, and a third planetary gear mechanism 10 are sequentially disposed. A rotational force of a rotary shaft 11 of the three-phase DC motor 7 is sequentially decelerated by the first planetary gear mechanism 8, the second planetary gear mechanism 9, and the third planetary gear mechanism 10, and is sequentially transmitted to an intermediate shaft 12 and an output shaft 13 disposed on the same axis as the rotary shaft 11. An arm 14 is fixed to a distal end portion of the output shaft 13. A link 15 is coupled to a distal end portion of the arm 14. The output shaft 13 of the actuator 5 is coupled to an intermediate portion of the left door hinge 3 via the arm 14 and the link 15.

The actuator 5 can assist the operation force in opening the back door 2 toward the fully opened position by driving the three-phase DC motor 7 and rotating the rotary shaft 11 in a predetermined direction, and can assist an operation force in closing the back door 2 toward the fully closed position by rotating the rotary shaft 11 in a reverse direction.

On the intermediate shaft 12 of the actuator 5, a magnetic ring 16, which is provided with one or a plurality of permanent magnets (not illustrated) at appropriate intervals (in a case of a plurality of permanent magnets) in a circumferential direction, is externally fitted together with other gears while rotating integrally with the intermediate shaft 12.

In the case 6, a sensor substrate 17 provided with a sensor unit (not illustrated) such as a Hall element faces the magnetic ring 16 and is wound to be integrated with the case 6. The sensor substrate 17 and the magnetic ring 16 constitute an in-unit sensor 18 that generates pulses corresponding to the opening and closing movement of the back door 2. The in-unit sensor 18 may be a rotary encoder.

Next, a configuration of the control device 30 will be described with reference to FIG. 4.

The control device 30 includes a main control unit 31 implemented by a microprocessor that executes a series of control processes in accordance with instructions of a control program stored in an internal memory, a pulse width modulation (PWM) control unit 32 that controls a voltage to be applied to the three-phase DC motor 7 based on PWM control instructed by the main control unit 31, and a relay output unit 33 switchable to drive the three-phase DC motor 7 in forward and reverse rotation directions based on instructions from the main control unit 31.

The main control unit 31 of the control device 30 is electrically connected to the in-unit sensor 18, the temperature sensor 19, the door distal end sensor 20, and the release switch 21 that detects an operation by an operator. Signals generated by the in-unit sensor 18, the temperature sensor 19, the door distal end sensor 20, and the release switch 21 are input to the main control unit 31 of the control device 30. The three-phase DC motor 7 is electrically connected to the PWM control unit 32 and the relay output unit 33 of the control device 30.

The main control unit 31 includes a state acquisition unit 311 that acquires a state of the back door 2, a control mode setting unit 312 that sets a control mode of the back door 2, a drive force calculation unit 313 that determines a duty ratio of the PWM control, and a motor circuit switching unit 314 that performs on and off control of the relay output unit 33.

The state acquisition unit 311 acquires information on the state of the back door 2 based on detection signals received from the in-unit sensor 18, the temperature sensor 19, the door distal end sensor 20, and the release switch 21. The state acquisition unit 311 acquires at least one of the acceleration (opening and closing acceleration), the speed (opening and closing speed), and the movement distance of the opening and closing movement of the back door 2 based on the detection signals received from the in-unit sensor 18, the temperature sensor 19, the door distal end sensor 20, and the release switch 21. A position and an angle of the back door 2, a movement direction of the opening and closing movement, the acceleration, the speed, and the movement distance are detected by calculation based on the number, a width, an interval, and the like of pulse signals output from the in-unit sensor 18 and calculation of the detection signal from the door distal end sensor 20. For example, on a premise that the three-phase DC motor 7 is stopped, the back door 2 is determined to be manually operated when the in-unit sensor 18 generates in succession a pulse signal whose pulse having a width smaller than a specified value occurs a specified number of times (for example, four or more), or when the door distal end sensor 20 generates an angle change signal.

In this manner, the state acquisition unit 311 can acquire information on the state of the back door 2 with a simple configuration by acquiring information on the state of the back door 2 based on the detection signals received from the in-unit sensor 18, the temperature sensor 19, the door distal end sensor 20, and the release switch 21.

The control mode setting unit 312 sets the control mode of the back door 2 based on the information on the state of the back door 2 acquired by the state acquisition unit 311. In the present embodiment, the control mode set by the control mode setting unit 312 includes a door holding control mode, a door balance control mode, and a power assistance control mode. The control device 30 can set and cancel door holding control, door balance control, and power assistance control based on the control mode set by the control mode setting unit 312. Details of the door holding control, the door balance control, and the power assistance control will be described later.

The drive force calculation unit 313 determines the duty ratio for the PWM control of the three-phase DC motor 7 based on the information on the state of the back door 2 acquired by the state acquisition unit 311 and the control mode set by the control mode setting unit 312, and outputs a control signal based on the determined duty ratio to the PWM control unit 32.

The motor circuit switching unit 314 outputs a control signal for performing on and off control of the relay output unit 33 to the relay output unit 33 based on the information on the state of the back door 2 acquired by the state acquisition unit 311 and the control mode set by the control mode setting unit 312.

Next, control of the door holding control, the door balance control, and the power assistance control will be described in detail.

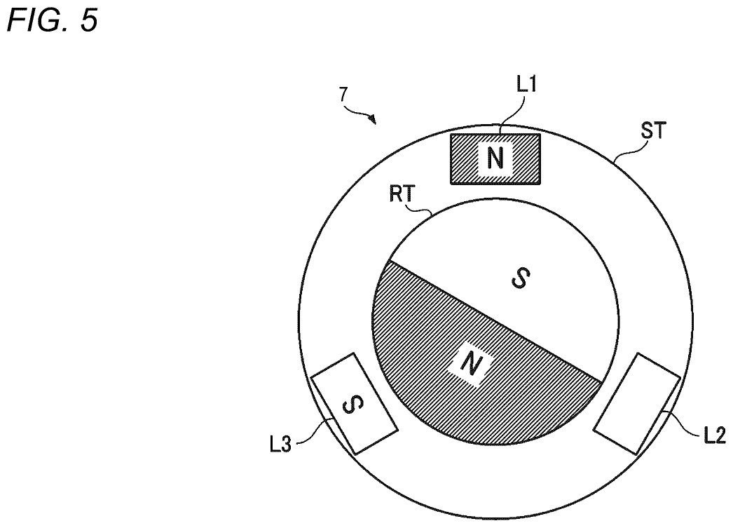

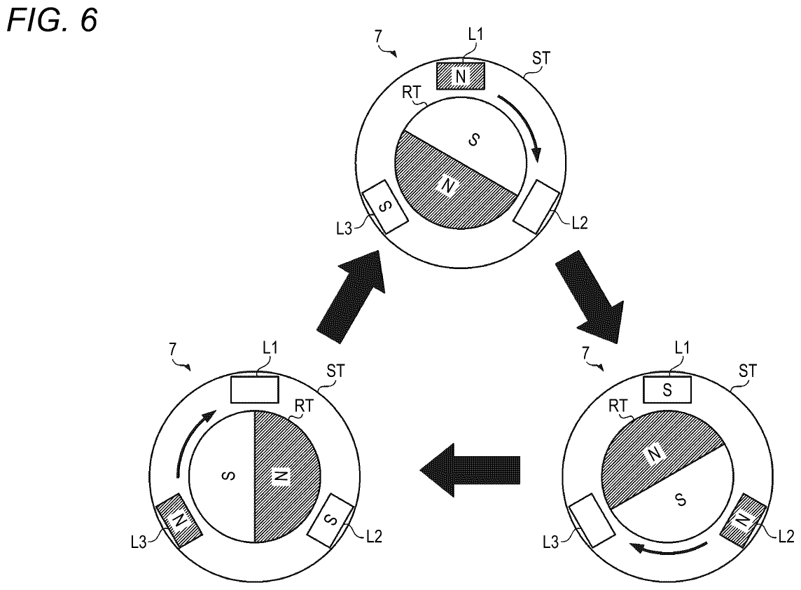

First, the door holding control will be described with reference to FIGS. 5 and 6.

The door holding control is control in which a holding force for maintaining an opening and closing position of the back door 2 is generated as a drive force of the three-phase DC motor 7, by controlling the three-phase DC motor 7 to a two-phase energized state.

FIG. 5 shows an example of the two-phase energized state. As illustrated in FIG. 5, the three-phase DC motor 7 is a three-phase brushless motor having two poles and three slots, and includes a stator ST having three coils L1, L2, and L3 (that is, three-phase coils) independent of each other, and a rotor RT having two poles and rotatable relative to the stator ST.

The two-phase energized state is a state that rotation of the rotor RT relative to the stator ST is braked, and is, for example, a state that currents having the same magnitude and in opposite directions flow through two (that is, two phases) of the three coils of the stator ST so that no rotating magnetic field is generated. FIG. 5 shows the two-phase energized state when the currents having the same magnitude and in opposite directions flow through the coils L1 and L3. When the three-phase DC motor 7 is in the two-phase energized state, the rotor RT is maintained in a stopped state in a predetermined rotational position relative to the stator ST by a magnetic force, and thus the holding force is generated.

However, even when the three-phase DC motor 7 is in the two-phase energized state, when a user who operates the back door 2 (hereinafter, also simply referred to as a “user”) inputs an operation force exceeding the holding force to the back door 2, the back door 2 performs the opening and closing movement by the operation force, and the rotor RT may accordingly rotate relative to the stator ST.

When energized phases during the door holding control (that is, when the three-phase DC motor 7 is in the two-phase energized state) are constant and the rotor RT rotates due to the input of the operation force exceeding the holding force, the holding force has a maximum value next time after the rotor RT rotates by an electrical angle of 360°. Accordingly, when the energized phases during the door holding control are constant, the movement of the back door 2 is intermittent even if the user operates the back door 2 with a constant operation force during the door holding control, and operability of the back door 2 during the door holding control may deteriorate.

The control device 30 sets the two energized phases according to a circumferential position of the rotor RT relative to the stator ST when the three-phase DC motor 7 is in the two-phase energized state in the door holding control.

FIG. 6 shows an example of a relationship between the phases energized by the door holding control and the circumferential position of the rotor RT. As shown in FIG. 6, during the door holding control, the control device 30 sets the two energized phases in accordance with the circumferential position of the rotor RT relative to the stator ST and brings the three-phase DC motor 7 into the two-phase energized state. In this manner, the holding force can have a maximum value each time the rotor RT rotates by an electrical angle of 120°. Accordingly, an intermittent feeling of the movement of the back door 2 during the door holding control can be relieved, and the operability of the back door 2 during the door holding control can be improved. The control device 30 acquires the rotational position of the rotor RT based on the detection signal from the in-unit sensor 18. When the three-phase DC motor 7 is in the two-phase energized state by the door holding control, the PWM control unit 32 refers to this information and energizes the two phases according to the rotational position of the rotor RT. For example, the control device 30 may store in advance information indicating the energized phases according to the rotational position of the rotor RT.

Next, the door balance control will be described with reference to FIG. 2.

The door balance control is control in which the output of the three-phase DC motor 7 is controlled by the PWM control to balance a component of the weight of the back door 2 in the opening and closing direction and the back door 2 is stationary.

As illustrated in FIG. 2, when an angle of the back door 2 relative to a vertical direction about a hinge shaft of the door hinge 3 is an angle θ viewed from the left-right direction, a mass of the back door 2 is a mass m [kg], and a gravitational acceleration is g [m/s²], a force of m·g [N] acts on the back door 2 vertically downward by its own weight. At this time, the component of the weight of the back door 2 in the opening and closing direction is m·g·sin θ [N].

In the door balance control, at this time, the three-phase DC motor 7 is controlled by the PWM control to generate an output of m·g·sin θ [N] in a direction opposite to the component of the weight of the back door 2 in the opening and closing direction. Accordingly, the component of the weight of the back door 2 in the opening and closing direction is balanced with the drive force output from the three-phase DC motor 7, and the back door 2 is in a stationary state.

Next, the power assistance control will be described.

The power assistance control is control in which a drive force is output from the three-phase DC motor 7 such that a predetermined assistance force is applied in an operation direction of the back door 2 when the back door 2 is manually opened and closed by the user.

In the power assistance control, the three-phase DC motor 7 may be controlled by the PWM control such that the predetermined assistance force is applied in the operation direction of the back door 2 based on an opening degree position of the back door 2 acquired by the state acquisition unit 311. For example, when the back door 2 moves in the intermediate area R3, the PWM control may be performed to decrease the duty ratio to gradually weaken the assistance force.

In the power assistance control, the three-phase DC motor 7 may also be controlled by the PWM control such that the predetermined assistance force is applied in the operation direction of the back door 2 based on an opening and closing operation speed of the back door 2. For example, the PWM control may be performed such that the duty ratio is increased as the manual opening and closing speed of the back door 2 is higher and is decreased as the manual opening and closing speed is lower. Accordingly, the assistance force corresponding to the manual opening and closing speed of the back door 2 can be applied, and thus the assistance control with high followability can be performed and the back door 2 can be manually operated by a natural operation.

In the power assistance control, the duty ratio may be determined in accordance with a vehicle posture when the vehicle V is parked, that is, an angle of the back door 2 when the back door 2 is in the fully closed position, and initial assistance control of the back door 2 in the opening direction from the fully closed position may be performed based on the duty ratio. The angle of the back door 2 in the fully closed position is detected by, for example, the door distal end sensor 20. For example, when the parking posture of the vehicle V is rearward and downward, an initial operation force when the back door 2 is moved in the opening direction from the closed position is larger than that when the parking posture is horizontal. Accordingly, the PWM control may be performed such that the duty ratio is larger than a specified value.

Further, immediately after switching to the power assistance control and immediately after canceling the power assistance control, the PWM control may be performed to gradually increase or decrease the duty ratio to eliminate a feeling of discomfort in the manual opening and closing operation.

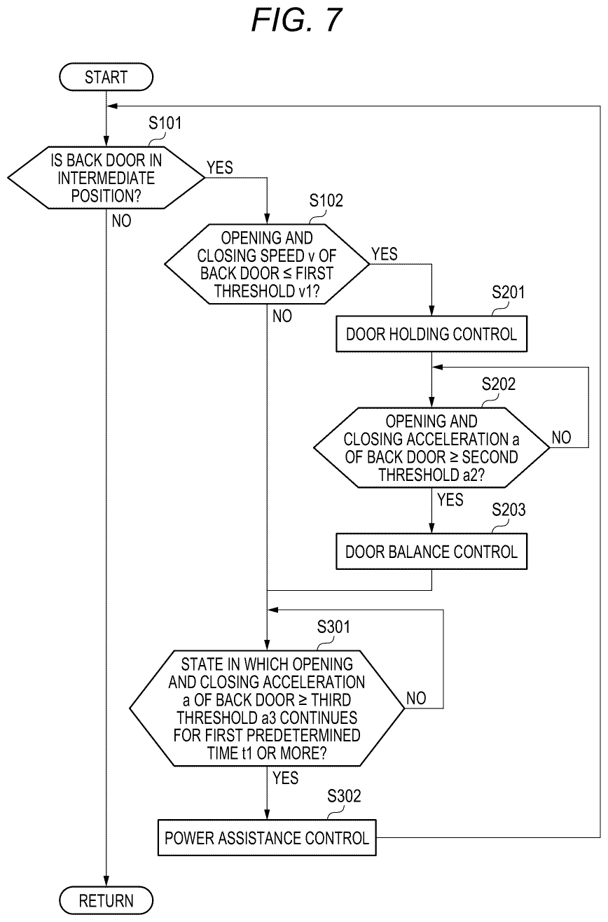

Next, assistance control performed when the back door 2 is opened and closed will be described with reference to FIG. 7.

In the assistance control, the process first proceeds to step S101, and the control device 30 determines, by the state acquisition unit 311, whether the back door 2 is in the intermediate position between the fully closed position and the fully opened position based on a signal from the door distal end sensor 20. When the back door 2 is not in the intermediate position between the fully closed position and the fully opened position (step S101: NO), that is, when the back door 2 is in the fully closed position or the fully opened position, a series of control is ended, and the process returns to the start. When the back door 2 is in the intermediate position between the fully closed position and the fully opened position (step S101: YES), the process proceeds to step S102.

In step S102, the control device 30 determines, by the state acquisition unit 311, whether an opening and closing speed v of the back door 2 is equal to or less than a first threshold v1 based on a signal from the door distal end sensor 20.

In step S102, when the opening and closing speed v of the back door 2 is determined to be not equal to or less than the first threshold v1 (step S102: NO), that is, when the opening and closing speed v of the back door 2 is determined to be more than the first threshold v1, the process proceeds to step S301 to be described later. In step S102, when the opening and closing speed v of the back door 2 is determined to be equal to or less than the first threshold v1 (step S102: YES), the process proceeds to step S201. In step S102, when the opening and closing speed v of the back door 2 is determined to be equal to or more than the first threshold v1 (step S102: YES), the process may proceed to S302 when the opening and closing acceleration is equal to or more than a third threshold, and to step S203 when the opening and closing acceleration is less than the third threshold.

In step S201, the control device 30 sets the control mode to the door holding control by the control mode setting unit 312. Then, the control device 30 starts the door holding control, and proceeds to step S202.

In step S202, the control device 30 determines, by the state acquisition unit 311, whether an operation force exceeding the holding force of the back door 2 by the door holding control is input to the back door 2 and an opening and closing acceleration a of the back door 2 is equal to or more than a second threshold a2 based on a signal from the door distal end sensor 20.

In step S202, when the opening and closing acceleration a of the back door 2 is not equal to or more than the second threshold a2, a waiting state is set in step S202 until the opening and closing acceleration a of the back door 2 is equal to or more than the second threshold a2 (step S202: loop of NO).

In step S202, when the opening and closing acceleration a of the back door 2 is equal to or more than the second threshold a2 (step S202: YES), the process proceeds to step S203, and the control device 30 switches the control mode from the door holding control to the door balance control by the control mode setting unit 312. Then, the control device 30 starts the door balance control, and proceeds to step S301.

In step S301, the control device 30 determines, by the state acquisition unit 311, whether the back door 2 is manually operated and an operation force is input to the back door 2 and a state that the opening and closing acceleration a of the back door 2 is equal to or more than a third threshold a3 continues for first predetermined time t1 or more based on a signal from the door distal end sensor 20.

In step S301, when the state that the opening and closing acceleration a of the back door 2 is equal to or more than the third threshold a3 does not continue for the first predetermined time t1 or more, a waiting state is set in step S301 until the state that the opening and closing acceleration a of the back door 2 is equal to or more than the third threshold a3 continues for the first predetermined time t1 or more (step S301: loop of NO).

In step S301, when the state that the opening and closing acceleration a of the back door 2 is equal to or more than the third threshold a3 continues for the first predetermined time t1 or more (step S301: YES), the process proceeds to step S302, and the control device 30 sets the control mode to the power assistance control by the control mode setting unit 312. Then, the control device 30 starts the power assistance control and returns to step S101.

According to the control mode setting unit 312, when the state that the opening and closing acceleration a of the back door 2 is equal to or more than the third threshold a3 continues for the first predetermined time t1 or more in a state that the door balance control is set, the door balance control is switched to the power assistance control.

By controlling the back door 2 in this manner, when the back door 2 is manually operated in a state of being stopped in the intermediate position, that the back door 2 is manually operated is quickly detected and the door holding control is canceled by two-phase energization, and the door balance control is performed so that the back door 2 would not be opened and closed by its own weight. Accordingly, the back door 2 can be held in a desired position in a state that the back door 2 can be easily opened and closed while reducing costs.

Even when the vehicle V is stopped on an inclined surface and the back door 2 is opened and closed, the inclination can be coped with without a switch for detecting the operation. Accordingly, easy-to-use assistance control that operates according to an intention of a person operating the back door 2 is possible.

### Second Embodiment

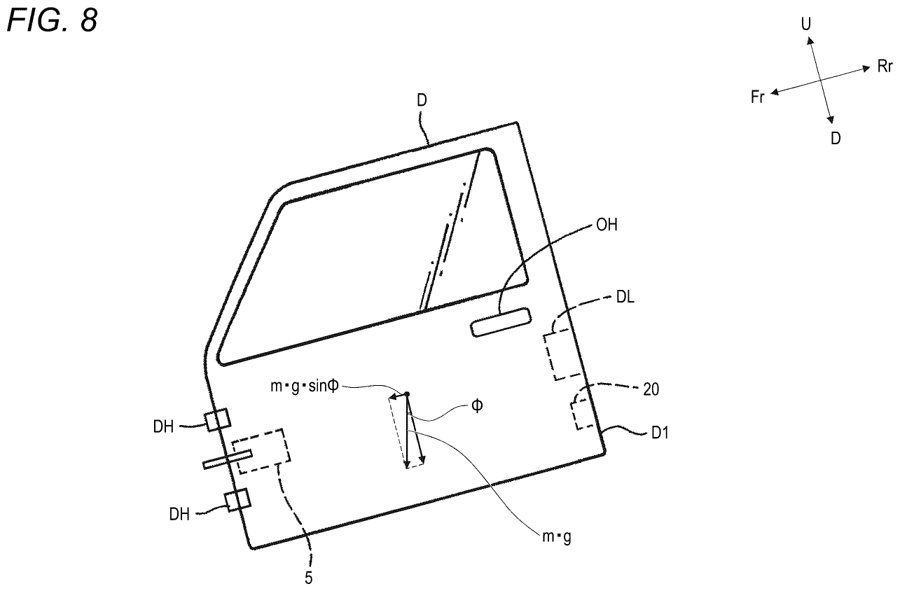

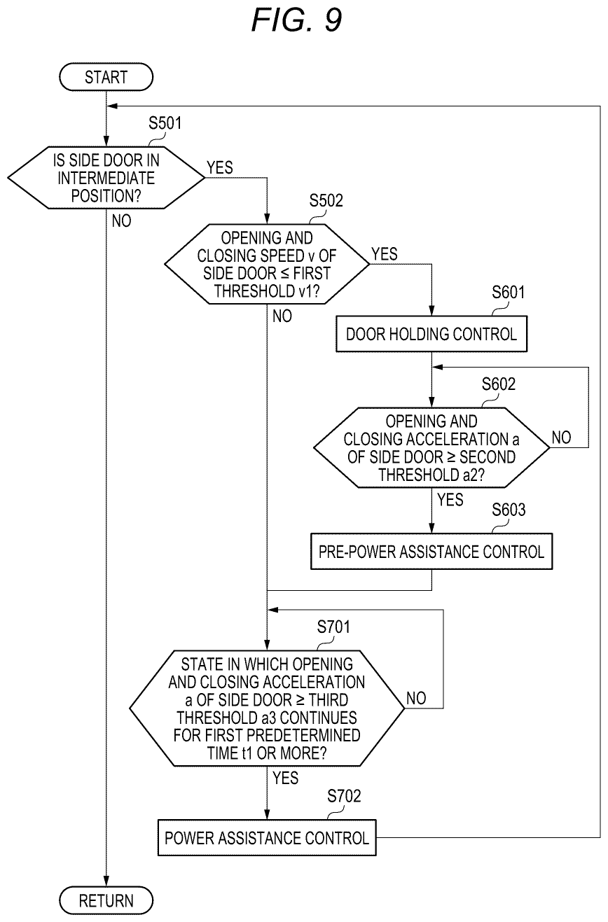

Next, as a second embodiment of the door opening and closing assistance device of the present disclosure, a door opening and closing assistance device that assists an operation force in opening and closing a side door of a vehicle will be described with reference to FIGS. 8 and 9. FIG. 8 illustrates a state that the vehicle V is located on a downward inclined surface to describe pre-power assistance control to be described later.

The door opening and closing assistance device 100 according to the present embodiment assists an operation force in opening and closing a side door D supported on a left side portion of the vehicle body 1 of the vehicle V.

As illustrated in FIG. 8, the side door D is a hinged door supported on the left side portion of the vehicle body 1 of the vehicle V. The side door D is supported on the vehicle body 1 of the vehicle V at the left side portion of the vehicle body 1 and allowed to be opened and closed in the left-right direction. The side door D is provided with a pair of upper and lower door hinges DH at a front end portion. The side door D is coupled to the left side portion of the vehicle body 1 via the door hinges DH, and is rotatable in the left-right direction about pivot shafts of the door hinges DH, which are provided at the front end portion of the side door D, directed toward the up-down direction.

The side door D is provided with, at a distal end portion D1 opposite to the front end portion of the side door D, the door latch device DL that holds the side door D in a fully closed position by meshing with a striker (not illustrated) on a vehicle body side.

The side door D is provided with, at the distal end portion D1, the door distal end sensor 20 similar to that of the first embodiment. The door distal end sensor 20 acquires a detection value for calculating at least one of an acceleration (opening and closing acceleration), a speed (opening and closing speed), and a movement distance of an opening and closing movement of the side door D.

Since the door distal end sensor 20 is attached to the distal end portion D1 opposite to the front end portion of the side door D, a movement amount of the door distal end sensor 20 is large when the side door D is opened and closed. Accordingly, the detection value for calculating at least one of the acceleration (opening and closing acceleration), the speed (opening and closing speed), and the movement distance of the opening and closing movement of the side door D can be relatively accurately acquired in the door distal end sensor 20.

The side door D is provided with, at a front portion, the actuator 5 similar to that of the first embodiment. The door opening and closing assistance device 100 according to the present embodiment activates the actuator 5 and applies an assistance force for opening and closing the side door D.

The gas spring 22 is preferably omitted from the side door D.

The side door D is provided with, on a left side surface, an outside handle OH that is operated when releasing the meshing between the door latch device DL and the striker and manually opening the side door D.

In the present embodiment, in the main control unit 31 of the control device 30, the state acquisition unit 311 acquires a state of the side door D, and the control mode setting unit 312 sets a control mode of the side door D based on information on the state of the side door D acquired by the state acquisition unit 311. In the present embodiment, the control mode set by the control mode setting unit 312 includes a door holding control mode, a pre-power assistance control mode, and a power assistance control mode. The control device 30 can set and cancel door holding control, pre-power assistance control, and power assistance control based on the control mode set by the control mode setting unit 312.

In the present embodiment, the door holding control is control in which a holding force for maintaining an opening and closing position of the side door D is generated as a drive force of the three-phase DC motor 7 by controlling the three-phase DC motor 7 to a two-phase energized state.

The pre-power assistance control is control in which an output of the three-phase DC motor 7 is controlled by PWM control such that a drive force obtained by adding a predetermined force to a force balanced with a component of a weight of the side door D in an opening and closing direction is generated in a direction opposite to the opening and closing direction due to the weight of the side door D, to move the side door D at a slow speed in the direction opposite to the opening and closing direction due to the weight of the side door D.

As illustrated in FIG. 8, when an angle of a hinge shaft of the door hinge DH relative to a vertical direction is an angle φ viewed from the left-right direction, a mass of the side door D is the mass m [kg], and the gravitational acceleration is g [m/s²], a force of m·g[N] acts on the side door D vertically downward by its own weight. At this time, the component of the weight of the side door D in the opening and closing direction is m·g·sin φ [N].

In the pre-power assistance control, at this time, the three-phase DC motor 7 is controlled by the PWM control to generate an output of m·g·sin θ+α [N] in a direction opposite to the component of the weight of the side door D in the opening and closing direction. Accordingly, the side door D operates with a drive force a in the direction opposite to the component of the weight of the side door D in the opening and closing direction by a resultant force of the component of the weight of the side door D in the opening and closing direction and the drive force output from the three-phase DC motor 7.

In the pre-power assistance control, the drive force a applied to the side door D in the direction opposite to the component of the weight of the side door D in the opening and closing direction is smaller than a drive force applied to the side door D during the power assistance control.

The power assistance control is control in which a drive force is output from the three-phase DC motor 7 such that a predetermined assistance force is applied in an operation direction of the side door D when the side door D is manually opened and closed by the user.

Next, assistance control performed when the side door D is opened and closed will be described with reference to FIG. 9.

In the assistance control, the process first proceeds to step S501, and the control device 30 determines, by the state acquisition unit 311, whether the side door D is in an intermediate position between the fully closed position and a fully opened position based on a signal from the door distal end sensor 20. When the side door D is not in the intermediate position between the fully closed position and the fully opened position (step S501: NO), that is, when the side door D is in the fully closed position or the fully opened position, a series of control is ended, and the process returns to the start. When the side door D is in the intermediate position between the fully closed position and the fully opened position (step S501: YES), the process proceeds to step S502.

In step S502, the control device 30 determines, by the state acquisition unit 311, whether the opening and closing speed v of the side door D is equal to or less than the first threshold v1 based on a signal from the door distal end sensor 20.

In step S502, when the opening and closing speed v of the side door D is determined to be not equal to or less than the first threshold v1 (step S502: NO), that is, when the opening and closing speed v of the side door D is determined to be more than the first threshold v1, the process proceeds to step S701 to be described later. In step S502, when the opening and closing speed v of the side door D is determined to be equal to or less than the first threshold v1 (step S502: YES), the process proceeds to step S601. In step S502, when the opening and closing speed v of the side door D is determined to be equal to or more than the first threshold v1 (step S502: YES), the process may proceed to S702 when the opening and closing acceleration is equal to or more than a third threshold, and to step S603 when the opening and closing acceleration is less than the third threshold.

In step S601, the control device 30 sets the control mode to the door holding control by the control mode setting unit 312. Then, the control device 30 starts the door holding control, and proceeds to step S602.

In step S602, the control device 30 determines, by the state acquisition unit 311, whether an operation force exceeding the holding force of the side door D by the door holding control is input to the side door D and the opening and closing acceleration a of the side door D is equal to or more than the second threshold a2 based on a signal from the door distal end sensor 20.

In step S602, when the opening and closing acceleration a of the side door D is not equal to or more than the second threshold a2, a waiting state is set in step S602 until the opening and closing acceleration a of the side door D is equal to or more than the second threshold a2 (step S602: loop of NO).

In step S602, when the opening and closing acceleration a of the side door D is equal to or more than the second threshold a2 (step S602: YES), the process proceeds to step S603, and the control device 30 switches the control mode from the door holding control to the pre-power assistance control by the control mode setting unit 312. Then, the control device 30 starts the pre-power assistance control, and proceeds to step S701.

In step S701, the control device 30 determines, by the state acquisition unit 311, whether the side door D is manually operated and an operation force is input to the side door D and a state that the opening and closing acceleration a of the side door D is equal to or more than the third threshold a3 continues for the first predetermined time t1 or more based on a signal from the door distal end sensor 20.

In step S701, when the state that the opening and closing acceleration a of the side door D is equal to or more than the third threshold a3 does not continue for the first predetermined time t1 or more, a waiting state is set in step S701 until the state that the opening and closing acceleration a of the side door D is equal to or more than the third threshold a3 continues for the first predetermined time t1 or more (step S701: loop of NO).

In step S701, when the state that the opening and closing acceleration a of the side door D is equal to or more than the third threshold a3 continues for the first predetermined time t1 or more (step S701: YES), the process proceeds to step S702, and the control device 30 sets the control mode to the power assistance control by the control mode setting unit 312. Then, the control device 30 starts the power assistance control and returns to step S501.

According to the control mode setting unit 312, when the state that the opening and closing acceleration a of the side door D is equal to or more than the third threshold a3 continues for the first predetermined time t1 or more in a state that the pre-power assistance control is set, the pre-power assistance control is switched to the power assistance control.

By controlling the side door D in this manner, when the side door D is manually operated in a state of being stopped in the intermediate position, that the side door D is manually operated is quickly detected and the door holding control is canceled by two-phase energization, and the pre-power assistance control is performed so that the side door D would not be opened and closed by its own weight. Accordingly, the side door D can be held in a vicinity of a desired position in a state that the side door D can be easily opened and closed while reducing costs. Further, in the pre-power assistance control, the side door D moves at a slow speed in the direction opposite to the opening and closing direction due to the weight of the side door D. Accordingly, a user can easily recognize that the pre-power assistance control is being performed and operability is excellent.

Even when the vehicle V is stopped on an inclined surface and the side door D is opened and closed, the inclination can be coped with without a switch for detecting the operation. Accordingly, easy-to-use assistance control that operates according to an intention of a person operating the side door D is possible.

Although the embodiments of the present disclosure are described above with reference to the accompanying drawings, it is needless to say that the present disclosure is not limited to these embodiments. It is apparent to a person skilled in the art that various modifications or corrections can be conceived within the scope described in the claims, and it is understood that the modifications or corrections naturally fall within a technical scope of the present disclosure. Components in the above embodiments may be freely combined without departing from the gist of the disclosure.

For example, the door distal end sensor 20 may be provided inside the door latch device DL. Accordingly, it is not necessary to separately ensure an attachment place of the door distal end sensor 20, and the door distal end sensor 20 may be attached to the distal end portion 2a of the back door 2 or the distal end portion D1 of the side door D.

Further, for example, the three-phase DC motor is controlled to be in the two-phase energized state in the door holding control, and the door may also be held by energizing three phases.

For example, in the first embodiment, when the opening and closing acceleration a of the back door 2 is equal to or more than the second threshold a2, the door holding control is switched to the door balance control. Alternatively, the door holding control may be switched to the door balance control when at least one of the opening and closing acceleration, the opening and closing speed, and the movement distance of the back door 2 is equal to or more than the second threshold.

Similarly, in the second embodiment, when the opening and closing acceleration a of the side door D is equal to or more than the second threshold a2, the door holding control is switched to the pre-power assistance control. Alternatively, the door holding control may be switched to the pre-power assistance control when at least one of the opening and closing acceleration, the opening and closing speed, and the movement distance of the side door D is equal to or more than the second threshold.

For example, the door opening and closing assistance device 100 according to the first embodiment assists the operation force in opening and closing the back door 2, and may also assist the operation force in opening and closing the side door D. That is, the control device 30 of the door opening and closing assistance device 100 that assists the operation force in opening and closing the side door D may set and cancel the door balance control.

Similarly, the door opening and closing assistance device 100 according to the second embodiment assists the operation force in opening and closing the side door D, and may also assist the operation force in opening and closing the back door 2. That is, the control device 30 of the door opening and closing assistance device 100 that assists the operation force in opening and closing the back door 2 may set and cancel the pre-power assistance control.

For example, the door opening and closing assistance device 100 according to the first embodiment assists the operation force in opening and closing the back door 2, and may also assist the operation force in opening and closing a slide door as a side door of the vehicle. When the angle relative to the vertical direction in the up-down direction of the vehicle is an angle ψ, a mass of a slide door is the mass m [kg], and the gravitational acceleration is g [m/s²], a force of m·g [N] acts on the slide door vertically downward by its own weight. At this time, considering that a component of the weight of the slide door in the opening and closing direction is m·g·sin ψ [N], the door opening and closing assistance device 100 may also assist an operation force in opening and closing the slide door. That is, the control device 30 of the door opening and closing assistance device 100 that assists the operation force in opening and closing the slide door may set and cancel the door balance control.

Similarly, the door opening and closing assistance device 100 according to the second embodiment assists the operation force in opening and closing the side door D, and may also assist the operation force in opening and closing a slide door as a side door of the vehicle. When the angle relative to the vertical direction in the up-down direction of the vehicle is the angle ψ, the mass of the slide door is m [kg], and the gravitational acceleration is g [m/s²], a force of m·g [N] acts vertically downward on the slide door by its own weight. At this time, considering that a component of the weight of the slide door in the opening and closing direction is m·g· sin ψ [N], the door opening and closing assistance device 100 may also assist an operation force in opening and closing the slide door. That is, the control device 30 of the door opening and closing assistance device 100 that assists the operation force in opening and closing the slide door may set and cancel the pre-power assistance control.

The present specification describes at least the following matters. Corresponding components and the like in the above-described embodiments are described in parentheses as an example, and the present disclosure is not limited thereto.

(1) A door opening and closing assistance device (door opening and closing assistance device 100), including:
a three-phase DC motor (three-phase DC motor 7) configured to generate power for assisting an operation force of a door (back door 2) that is supported on a vehicle body (vehicle body 1) and allowed to be opened and closed; and
a controller (control device 30) configured to control the three-phase DC motor,
in which the controller is configured to set and cancel
   door balance control in which an output of the three-phase DC motor is controlled to balance a component of a weight of the door in an opening and closing direction of the door such that the door is stationary, and
   power assistance control in which the output of the three-phase DC motor is controlled to generate an assistance force in the opening and closing direction of the door, and
when a state that an opening and closing acceleration (opening and closing acceleration a) of the door is equal to or more than a third threshold (third threshold a3) continues for predetermined time (first predetermined time t1) or more in a state that the door balance control is set, the controller switches from the door balance control to the power assistance control.

According to (1), the door can be held in a vicinity of a desired position in a state that a door opening and closing operation can be easily performed. Accordingly, the door can be held in the vicinity of the desired position in a state that the door opening and closing operation can be easily performed while reducing costs.

(2) A door opening and closing assistance device (door opening and closing assistance device 100), including:
a three-phase DC motor (three-phase DC motor 7) configured to generate power for assisting an operation force of a door (side door D) that is supported on a vehicle body (vehicle body 1) and allowed to be opened and closed; and
a controller (control device 30) configured to control the three-phase DC motor,
in which the controller is configured to set and cancel
   pre-power assistance control in which an output of the three-phase DC motor is controlled such that a resultant force with a component of a weight of the door in an opening and closing direction of the door has a predetermined magnitude in a direction opposite to the opening and closing direction due to the weight of the door, to move the door, and
   power assistance control in which the output of the three-phase DC motor is controlled to generate an assistance force in the opening and closing direction of the door, and
when a state that an opening and closing acceleration (opening and closing acceleration a) of the door is equal to or more than a third threshold (third threshold a3) continues for predetermined time (first predetermined time t1) or more in a state that the pre-power assistance control is set, the controller switches from the pre-power assistance control to the power assistance control.

According to (2), the door can be held in a vicinity of a desired position in a state that a door opening and closing operation can be easily performed. Accordingly, the door can be held in the vicinity of the desired position in a state that the door opening and closing operation can be easily performed while reducing costs.

(3) The door opening and closing assistance device according to (1),
in which the controller is configured to set and cancel door holding control of maintaining a position of the door in which at least two phases of the three-phase DC motor are energized, and set energized phases according to a circumferential position of a rotor (rotor RT) relative to a stator (stator ST) of the three-phase DC motor,
the door holding control is set when an opening and closing speed (opening and closing speed v) of the door is equal to or less than a first threshold (first threshold v1), and
when at least one of the opening and closing acceleration, the opening and closing speed, and a movement distance of the door is equal to or more than a second threshold (second threshold a2) in a state that the door holding control is set, the controller switches from the door holding control to the door balance control.

According to (3), a holding force can have a maximum value each time the rotor RT rotates by an electrical angle of 120°. Accordingly, an intermittent feeling of the movement of the door during the door holding control can be relieved, and operability of the door during the door holding control can be improved.

(4) The door opening and closing assistance device according to (2),
in which the controller is configured to set and cancel door holding control of maintaining a position of the door in which at least two phases of the three-phase DC motor are energized, and set energized phases according to a circumferential position of a rotor (rotor RT) relative to a stator (stator ST) of the three-phase DC motor,
the door holding control is started when an opening and closing speed (opening and closing speed v) of the door is equal to or less than a first threshold (first threshold v1), and
when at least one of the opening and closing acceleration, the opening and closing speed, and a movement distance of the door is equal to or more than a second threshold (second threshold a2) in a state that the door holding control is set, the controller switches from the door holding control to the pre-power assistance control.

According to (4), a holding force can have a maximum value each time the rotor RT rotates by an electrical angle of 120°. Accordingly, an intermittent feeling of the movement of the door during the door holding control can be relieved, and operability of the door during the door holding control can be improved.

(5) The door opening and closing assistance device according to any one of (1) to (4), further including:
a sensor (door distal end sensor 20) attached to the door,
in which the controller is configured to acquire at least one of the opening and closing acceleration, an opening and closing speed, and a movement distance of the door based on a detection value of the sensor.

According to (5), at least one of the opening and closing acceleration, the opening and closing speed, and the movement distance of the door is acquired based on the detection value of the sensor attached to the door. Accordingly, at least one of the opening and closing acceleration, the opening and closing speed, and the movement distance of the door can be acquired with a simple configuration.

(6) The door opening and closing assistance device according to (5),
in which the door opening and closing assistance device is coupled to the vehicle body via a door hinge (door hinge 3, door hinge DH) provided at a one end portion thereof, and assists an opening and closing operation of a hinged door (back door 2, side door D) rotatable about a pivot shaft of the door hinge, and
the sensor is attached to an other end portion (distal end portion 2a, distal end portion D1) of the hinged door opposite to the one end portion.

According to (6), the sensor is attached to the other end portion of the door on a side opposite to a side where the door hinge is provided. Accordingly, a movement amount of the sensor increases when the door is opened or closed. Accordingly, a detection value for calculating at least one of the opening and closing acceleration, the opening and closing speed, and the movement distance of the door can be relatively accurately acquired in the sensor.

(7) The door opening and closing assistance device according to (6),
in which the sensor is provided inside a door latch device (door latch device DL) of the hinged door.

According to (7), it is not necessary to separately ensure an attachment place of the sensor, and the sensor can be attached to the other end portion of the door on the side opposite to the side where the door hinge is provided.

What is claimed is:

1. A door opening and closing assistance device, comprising:
a three-phase DC motor configured to generate power for assisting an operation force of a door that is supported on a vehicle body and allowed to be opened and closed; and
a controller configured to control the three-phase DC motor,
wherein the controller is configured to set and cancel
door balance control in which an output of the three-phase DC motor is controlled to balance a component of a weight of the door in an opening and closing direction of the door such that the door is stationary, and
power assistance control in which the output of the three-phase DC motor is controlled to generate an assistance force in the opening and closing direction of the door, and
when a state that an opening and closing acceleration of the door is equal to or more than a third threshold continues for predetermined time or more in a state that the door balance control is set, the controller switches from the door balance control to the power assistance control.

2. A door opening and closing assistance device, comprising:
a three-phase DC motor configured to assist an operation force of a door that is supported on a vehicle body and allowed to be opened and closed; and
a controller configured to control the three-phase DC motor,
wherein the controller is configured to set and cancel
pre-power assistance control in which an output of the three-phase DC motor is controlled such that a resultant force with a component of a weight of the door in an opening and closing direction of the door has a predetermined magnitude in a direction opposite to the opening and closing direction due to the weight of the door, to move the door, and
power assistance control in which the output of the three-phase DC motor is controlled to generate an assistance force in the opening and closing direction of the door, and
when a state that an opening and closing acceleration of the door is equal to or more than a third threshold continues for predetermined time or more in a state that the pre-power assistance control is set, the controller switches from the pre-power assistance control to the power assistance control.

3. The door opening and closing assistance device according to claim 1,
wherein the controller is configured to set and cancel door holding control of maintaining a position of the door in which at least two phases of the three-phase DC motor are energized, and set energized phases according to a circumferential position of a rotor relative to a stator of the three-phase DC motor,
the door holding control is set when an opening and closing speed of the door is equal to or less than a first threshold, and
when at least one of the opening and closing acceleration, the opening and closing speed, and a movement distance of the door is equal to or more than a second threshold in a state that the door holding control is set, the controller switches from the door holding control to the door balance control.

4. The door opening and closing assistance device according to claim 2,
wherein the controller is configured to set and cancel door holding control of maintaining a position of the door in which at least two phases of the three-phase DC motor are energized, and set energized phases according to a circumferential position of a rotor relative to a stator of the three-phase DC motor,
the door holding control is started when an opening and closing speed of the door is equal to or less than a first threshold, and
when at least one of the opening and closing acceleration, the opening and closing speed, and a movement distance of the door is equal to or more than a second threshold in a state that the door holding control is set, the controller switches from the door holding control to the pre-power assistance control.

5. The door opening and closing assistance device according to claim 1, further comprising:
a sensor attached to the door,
wherein the controller is configured to acquire at least one of the opening and closing acceleration, an opening and closing speed, and a movement distance of the door based on a detection value of the sensor.

6. The door opening and closing assistance device according to claim 2, further comprising:
a sensor attached to the door,
wherein the controller is configured to acquire at least one of the opening and closing acceleration, an opening and closing speed, and a movement distance of the door based on a detection value of the sensor.

7. The door opening and closing assistance device according to claim 5,
wherein the door opening and closing assistance device is coupled to the vehicle body via a door hinge provided at a one end portion thereof, and assists an opening and closing operation of a hinged door rotatable about a pivot shaft of the door hinge, and
the sensor is attached to an other end portion of the hinged door opposite to the one end portion.

8. The door opening and closing assistance device according to claim 6,
wherein the door opening and closing assistance device is coupled to the vehicle body via a door hinge provided at a one end portion thereof, and assists an opening and closing operation of a hinged door rotatable about a pivot shaft of the door hinge, and
the sensor is attached to an other end portion of the hinged door opposite to the one end portion.

9. The door opening and closing assistance device according to claim 7,
wherein the sensor is provided inside a door latch device of the hinged door.

10. The door opening and closing assistance device according to claim 8,
wherein the sensor is provided inside a door latch device of the hinged door.
